(19) United States
(12) Patent Application Publication
(10) Pub. No.: US 2003/0133187 A1
(43) Pub. Date: Jul. 17, 2003

(54) Observation instrument for a stereoscopic operation microscope

(76) Inventors: Martin Schmidt, Bad Schwartau (DE); Wilhelm Duis, Hetlingen (DE); Richard D. Bucholz, Lade, MO (US)

Correspondence Address: ALIX YALE & RISTAS LLP, 750 MAIN STREET, SUITE 1400, HARTFORD, CT, 06103, US

(21) Appl. No.: 10/285,866

(22) Filed: Nov. 1, 2002

(30) Foreign Application Priority Data
Nov. 2, 2001 (EP) 01 126 116.1

(51) Int. Cl. G02B 21/22

(52) U.S. Cl. 359/376; 359/368; 359/381; 359/385; 359/431

(57) ABSTRACT

The observation instrument for a stereoscopic operation microscope, with input connections (1) for the two beam paths (2, 7, 19) of the operation microscope, with instruments (8) for connecting observation tubes for the main observer, with display-screen units (11) and projection instruments (13) for projecting the images from the display-screen units (11) into the observation beam paths (2, 7, 19), with instruments for connecting video cameras and with instruments (10) for connecting tubes for a co-observer, is distinguished in that the following are arranged in each of the two beam paths behind the input connections (1), as viewed in the direction of the beam paths (2, 7, 19): a first beam splitter (3) for deviating a part of the light of the observation beam path into a video camera, behind this a switchable shutter (4) for attenuating and/or blocking the light of the observation beam path, and behind this an optical element (21, 23) with a second beam splitter (22), which splits the light of the observation beam path and the light from the projection instrument (13) into two beams for the observation tube and for the co-observer tube of this beam path.

The invention relates to an instrument for a stereoscopic operation microscope, with input connections for the two beam paths of the operation microscope, with instruments for connecting observation tubes for the main observer, with display-screen units and projection instruments for projecting the images from the display-screen units into the observation beam paths, with instruments for connecting video cameras and with instruments for connecting tubes for a co-observer.

For microsurgical interventions, operation microscopes are regularly used so that operations can be carried out on fine biological structures. Depending on the operation, assistants collaborate in this. For particular operations, for example in brain surgery, the assistant is usually located at the surgeon's side, either on the left or on the right of the surgeon depending on the situation in the operating theatre. For other operations, for example on the spinal column, the two surgeons stand or sit opposite one another, each on one side of the operating table. For all operations, however, a video camera which records the operation procedure needs to be fitted to the operation microscope. In neurosurgery, it is furthermore customary for data or graphics to be overlaid, for example trajectories which indicate particular navigation directions and are generated in navigation systems. It has also become customary for other images, for example from endoscopes, to be overlaid in the eyepiece so that they appear in a part of the field of view, whereas the remaining larger part of the field of view continues to show the operation procedure.

In order to fulfil all these requirements, it is now still customary for the operation microscope to be refitted between the operations and to be configured for the respective requirement of the subsequent operations. This refitting, however, entails considerable time expenditure and involves the risk of errors in setting up and balancing the microscope stand.

Operation microscopes which have all functions integrated are therefore available on the market. These, however, are very large and expensive, and the light outputs for the co-observers are unfavourably arranged either on the side of the operation microscope or on the back. For overlaying video images in the beam path, for example for navigation, beam splitters are required which reduce the luminosity of the operation microscope for the observers.

The technical solution for overlaying endoscope images necessitates either a large module in the region of the eyepieces, which is positioned detrimentally owing to the proximity to the surgeon, or intermediate image formation in the beam path of the operation microscope, which lengthens the optical beam path-length and therefore the microscope, and which requires additional optics.

The aforementioned solutions furthermore have the disadvantage that, in the case of multidisciplinary use, for example on peripheral nerves or in the ENT region, the above properties are not needed. Operation microscopes which contain all these properties therefore involve an unnecessary hindrance owing to size and weight.

It is an object of the invention to provide an observation instrument of the type mentioned at the start, which is compactly constructed and in which less light is lost than in previously known instruments.

The solution according to the invention consists in that the following are arranged in each of the two beam paths behind the input connections, as viewed in the direction of the beam paths: a first beam splitter for deviating a part of the light of the observation beam path into a video camera, behind this a switchable shutter for attenuating and/or blocking the light of the observation beam path, and behind this an optical element with a second beam splitter, which splits the light from the projection instrument into two beams for the observation tube and for the co-observer tube of this beam path.

In each of the two beam paths, a first beam splitter which diverts a part of the light of the observation beam path into a video camera is provided behind the input connections for the light of the observation beam paths. Owing to the high sensitivity of modern video cameras, only a small part of the light, 20% and advantageously 10%, needs to be deviated laterally, so that the light intensity in the main beam path is scarcely reduced. Behind this first beam splitter, each beam path contains a switchable shutter for attenuating and/or blocking the light of the observation beam path. This attenuation or blocking of the light of the observation beam path makes it possible to additionally overlay an image in the observation beam path or merely to generate an image which is generated by display-screen units of each of the two beam paths. A second beam splitter is arranged behind the shutter, and it splits both the light of the observation beam path and the light from the projection instrument into two beams for the observation tube and for the co-observer tube of this beam path. This beam splitter hence has two functions at the same time. Two separate beam splitters are not necessary, which on the one hand would take up more space and, on the other hand, would lead to more loss of light.

Advantageously, the optical elements which contain the second beam splitters have two prisms which are joined together at a surface which forms the second beam splitter.

It has proved particularly expedient in this case for one of the prisms to be a Bauernfeind prism.

In a particularly simple embodiment, the shutter can be actuated by hand, in order to attenuate or block the light of the observation beam path. The shutter may, however, also be actuable by an electromechanical instrument, which may have an electromagnet, an electric motor, in particular a stepper motor. A particularly space-saving design is obtained if the first beam splitter is designed as a geometrical beam splitter.

In order to reduce the optical path-length, and therefore to achieve a smaller overall size, provision may expediently be made for additional glass elements to be provided in the beam paths, the optical elements expediently having these glass elements.

LCD units, in particular 0.5 inch LCD units, have been found to be particularly advantageous as display-screen units.

The observation instrument can be used in a particularly versatile way if a rotatable reflection instrument, with which the light can be diverted to a co-observer tube arranged opposite the main observer or to a laterally arranged observation instrument, is provided in at least one of the beam paths. If the light is sent to a co-observer tube arranged opposite the main observer, then he or she can stereoscopically observe the processes just like the main observer can. If the light is deviated to the side, only one of the beam paths can respectively be observed here. An observer could observe the image without the stereo effect here. A camera could also be connected here. If two such reflection instruments are provided, then a camera could be connected on one side and an observer tube could be provided on the other side. It would also be conceivable to deviate only one beam path away from the co-observer tube arranged opposite and to direct it laterally, for example into a video camera.

The observation instrument, as stated above, is particularly space-saving and does not substantially increase the volume and weight of the operation microscope. Expediently, the observation instrument of the invention is in this case designed as a dismountable module, so that the operation microscope can be used for simple purposes in a minimal configuration.

The invention will be explained below with the aid of an advantageous embodiment with reference to the appended drawings, in which, as schematic views:

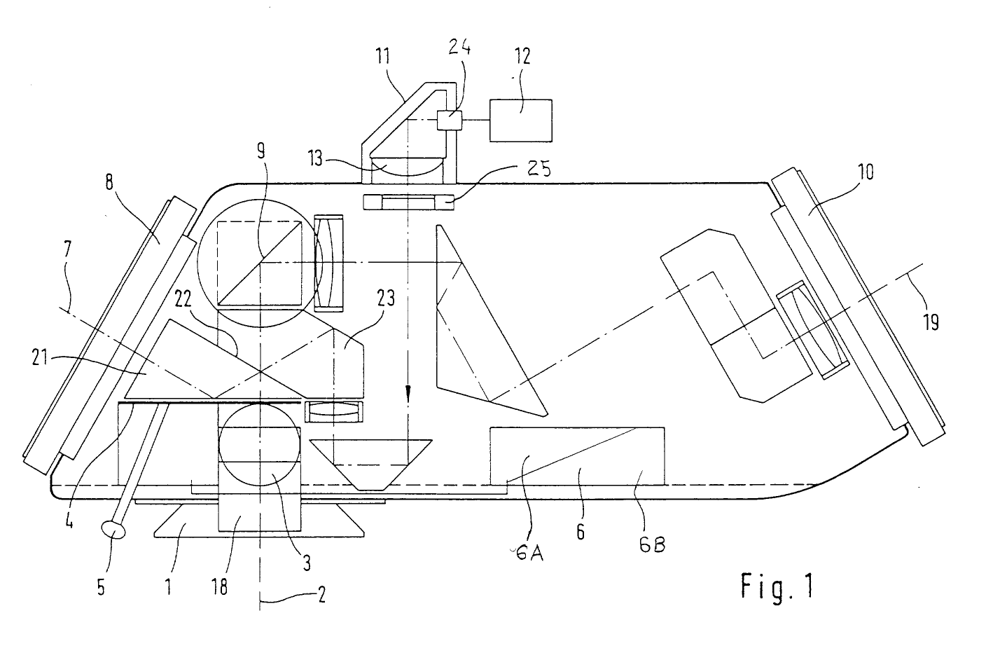

FIG. 1 shows a section of an observation instrument of the invention from the side;

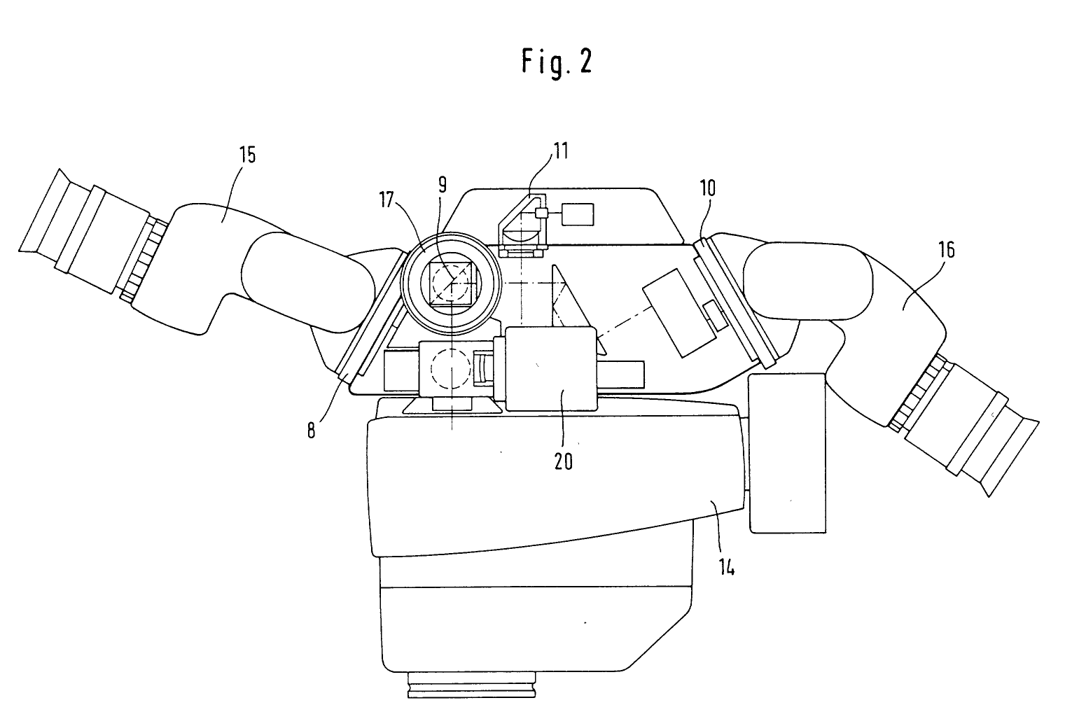

FIG. 2 shows, partially cut-away, the observation instrument of FIG. 1 which is mounted on a microscope; and

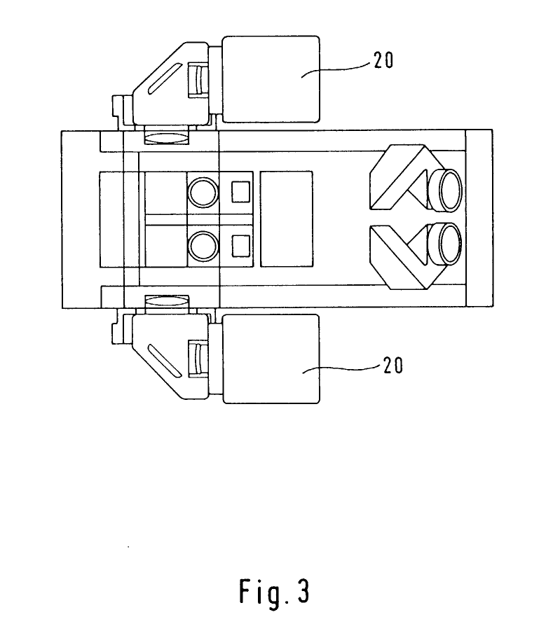

FIG. 3 shows the arrangement of FIG. 2 from above.

Reference will firstly be made to FIG. 1. The observation instrument of the invention is provided with input connections 1, via which both observation beam paths 2 of the microscope enter the observation instrument. Only one beam path with associated components is respectively shown in FIG. 1. Directly behind the input connections 1, first beam splitters 3 are provided, with which a small part of the light, advantageously 20% or even better only 10%, is deviated laterally, that is to say perpendicularly from the plane of the paper. On both sides of the observation instrument, this light is introduced into video cameras 20, which are shown in FIGS. 2 and 3. Behind the first beam splitters 3, there are shutters 4 which, with the aid of a lever 5 or an electromechanical controller 6, can be closed fully or partially in order to attenuate or block the light 2 of the observation beam paths. The light passing through the shutters 4 respectively enters a first prism 21 with a beam-splitter surface 22, by which a light component 7 is diverted to an instrument 8 for connecting an observation tube for the main observer. The other part of the light is sent through a rotatable reflection instrument 9 via further optical elements to an instrument 10 for fitting a tube for a co-observer. The reflection instrument 9 is in this case rotatable about an axis, which lies in the plane of the paper in FIG. 1 and is vertical. If this reflection instrument 9, which is designed there as a prism but which could also be a mirror, is rotated through 90°, then this beam path is not directed to the connection instrument 10, but is instead deviated away laterally, where a co-observer tube or a video camera may be arranged.

The observation instrument furthermore has, at 11, a display-screen unit in which an image can be generated with the aid of electronic circuits 12. This image is directed through a lens 13 and further suitable optical elements 1, shown in FIG. 1, into a prism 23 which is assembled with the prism 21 and has the beam-splitter surface 22 in common with it. A part of the light coming from the display-screen unit 11 is in this case sent into the beam path 7 for the main observer, whereas the other part is diverted away laterally by means of the reflection instrument 9, either to the connection device for the co-observer tube into the beam path 19 for the co-observer or, alternatively, together with the main beam path.

The assembled prisms 21, 23 with a common interface 22, which acts as a second beam splitter, hence respectively split both the main beam path of the microscope and the beam path of the display-screen units into beam paths for the main observer and the co-observer. Since only one second beam splitter is respectively provided, a smaller overall size is obtained, as well as the advantage of smaller light losses.

In FIG. 2, the observation instrument according to the invention is shown in the mounted state, in which it is fastened on an operation microscope 14 and has tubes 15 for the main observer and 16 for the co-observer. In this case, one of the video cameras 20 is also shown, which receives the light from the first beam splitter 3. A connection 17 is furthermore shown, to which it is possible to fit a co-observer tube or a camera, which receives the light via the reflection instrument 9 when the latter is rotated through 90° in relation to the position shown in FIGS. 1 and 2.

The lateral arrangement of the video cameras 20 can be seen clearly in FIG. 3, which shows from above the observation instrument with parts fitted on.

The display-screen units 11 advantageously have 0.5 inch LCD units. At least one additional glass element, which is denoted by 18 in FIG. 1, may be arranged in each beam path in order to reduce the optical path-length. This glass element 18 may expediently be an integral component of the optical element which is formed by the prisms 21, 23. The optical path-length of the beam paths 2, 7 to the main observer and 2, 19 to the co-observer are thereby reduced.

Details of the electromechanical instrument 6, which may have an electromagnet, and electric motor, in particular a stepper motor, are not shown in the figures because such instruments are well known to the person skilled in the art.

Likewise not shown are video cameras, which can be fitted on the instrument 17 of the reflection instrument 9, since such via cameras may correspond to the video cameras 20. A tube which corresponds to one of the tubes 15 or 16 may also be fitted on the instrument 17. The reflection instrument 9 may in this case be configured either as a mirrored glass plate or as a prism with mirroring on the back or total reflection. Using a mechanism which is not shown in the drawing, the reflection instrument 9 can be rotated through 90° either with a lever from the outside or using an electric-motor or electromagnetic drive.

As already mentioned, the observation instrument can be kept very compact owing to the selected optical arrangement. For instance, the observer tube 15 can be kept close to the microscope body. The tubes 15, 16 can also be fitted approximately at the same height. The connections 8, 10 may in this case be rotatably designed. The eyepieces can thereby be rotated into a horizontal position even with an oblique setting of the microscope, which provides significant facilitation for the surgeon.

Various modes of operation are then possible with the observation instrument.

1. Without overlay of information from the display-screen units 11, the light is optimally distributed between the two cameras 20, to the main observer and the co-observer. If the co-observer is located at the side, he or she receives the light from one of the optical channels via the reflection instrument 9, whereas the light of the other optical channel can be used by a further camera, for example a 35 mm camera. If the co-observer is arranged opposite the main observer, he or she receives the light of both optical channels. For photography using a 35 mm camera, it is then possible to briefly switch over the reflection instrument 9 to lateral deviation of the beam path in one of the observation channels.

2. If images or data from a navigation system assisting the operator is to be overlaid then, in addition to the mode of operation described in 1., light from the display-screen unit 11 is overlaid in one or both channels by the projection unit 13.

3. For the observation of endoscope images, the shutter 4 is closed or partially closed on one or both sides, so that the direct view is darkened or fully blocked. The cameras 20, however, continue to receive light via the beam splitters 3. The camera signal can only be mixed with the endoscope image by means of external electronic processing, which is not shown in the figures, in such a way as to form a window in the field of view, in which the endoscope image is shown. The corresponding window technique is known nowadays both in PC technology and in television technology.

4. Modern navigation systems permit the stereotypic overlay of tumours which lie below the tissue surface. The correct depth impression, however, requires calibration with the stereoscopic image coming from the direct view. Such calibration is very difficult or impossible for the mixing of video images with direct images. By mixing in an electronic unit, however, the images coming from the camera 20 can be correlated with the navigation images, by means of landmarks, in such a way that a realistic depth estimate of the tumour position is possible.

Operation microscopes are normally designed and equipped for stereoscopic operation. The principle of the invention, however, may nevertheless be used readily even for monoscopic microscopes, in which case the relevant optical elements respectively need to be provided only singly and not in pairs. This embodiment likewise falls within the scope of the invention. It is also possible for the display-screen unit with the corresponding projection unit to be configured as a separate additional part, which may optionally be retrofitted later. It would also be conceivable to design the second beam splitter or splitters not integrally, but instead to provide two separate beam splitters for each of these beam splitters, although this has the disadvantage that the overall size is thereby increased and the light is also attenuated more.

1. Observation instrument for a stereoscopic operation microscope, with input connections (1) for the two beam paths (2, 7, 19) of the operation microscope, with instruments (8) for connecting observation tubes (15) for the main observer, with display-screen units (11) and projection instruments (13) for projecting the images from the display-screen units (11) into the observation beam paths (2, 7, 19), with instruments for connecting video cameras and with instruments (10) for connecting tubes (16) for a co-observer, characterized in that the following are arranged in each of the two beam paths behind the input connections (1), as viewed in the direction of the beam paths (2, 7, 19): a first beam splitter (3) for deviating a part of the light of the observation beam path into a video camera (20), behind this a switchable shutter (4) for attenuating and/or blocking the light of the observation beam path, and behind this an optical element (21, 23) with a second beam splitter (22), which splits the light from the projection instrument (13) into two beams for the observation tube (15) and for the co-observer tube (16) of this beam path.

2. Observation instrument according to claim 1, characterized in that the optical elements have two prisms (21, 23), which are joined together at a surface which forms the second beam splitter (22).

3. Observation instrument according to claim 2, characterized in that one of the prisms (21, 23) is a Bauernfeind prism.

4. Observation instrument according to one of claims 1 to 3, characterized in that the shutter (4) can be actuated by hand with a lever (5).

5. Observation instrument according to one of claims 1 to 3, characterized in that the shutter (4) can be actuated by an electromechanical instrument (6).

6. Observation instrument according to claim 5, characterized in that the electromagnetic instrument (6) has an electromagnet, an electric motor, in particular a stepper motor.

7. Observation instrument according to one of claims 1 to 6, characterized in that the first beam splitters (3) are designed as geometrical beam splitters, whose light extraction is less than 20 percent, advantageously less than 10 percent.

8. Observation instrument according to one of claims 1 to 7, characterized in that below the optical elements (21, 23) there is at least one additional glass element (18) in the beam path for reducing the optical path-length.

9. Observation instrument according to one of claims 1 to 8, characterized in that the display-screen units (11) have LCD units.

10. Observation instrument according to one of claims 1 to 9, characterized in that a rotatable reflection instrument (9), with which the light can be diverted to a co-observer tube (16) arranged opposite the main observer or to a laterally arranged observation instrument, is provided in at least one of the beam paths.

11. Observation instrument according to claim 10, characterized in that one observation instrument is a tube for a co-observer.

12. Observation instrument according to claim 10 or 11, characterized in that one observation instrument is a camera.

13. Observation instrument according to one of claims 1 to 12, characterized in that it is designed as a dismountable module.

14. Observation instrument according to one of claims 1 to 13, characterized in that it is designed monoscopically with only one set of the optical elements.
